(19) United States
(12) Patent Application Publication
(10) Pub. No.: US 2015/0356956 A1
(43) Pub. Date: Dec. 10, 2015

(54) TREMOLO DEVICE

(71) Applicant: Tony Rukavina, (US)

(72) Inventor: Tony RUKAVINA, Coquitlam (CA)

(73) Assignee: Tony Rukavina, Coquitlam (CA)

(21) Appl. No.: 14/718,945

(22) Filed: May 21, 2015

(30) Foreign Application Priority Data
May 21, 2014 (CA) 2852307

(51) Int. Cl. G10D 3/14

(52) U.S. Cl. CPC G10D 3/146

(57) ABSTRACT

The invention provides a tremolo device for a stringed instrument. The tremolo device comprises a base plate, which comprises a leading edge comprising an elongate bearing surface, the elongate bearing surface defining an engagement end at a first end of the elongate bearing surface and a free end at a second end of the elongate bearing surface. The tremolo device further comprises a pivot rail, which comprises an elongate pivot bearing surface with a mating end at one end, so that when the base plate is engaged with the pivot rail, the engagement end of the elongate bearing surface is matingly engaged with the mating end of the pivot rail, to secure pivotal contact between the elongate bearing surface and the elongate pivot bearing surface preventing separation of the base plate from the pivot rail while allowing rotation of the base plate about a longitudinal axis of the pivot rail.

### CROSS REFERENCE TO RELATED APPLICATION

This application claims priority upon Canadian Application No. 2,852,307, filed May 21, 2014. This application is hereby incorporated by reference in its entirety for all of its teachings.

### FIELD OF INVENTION

The present disclosure relates to a tremolo device for a stringed instrument. More particularly, the present disclosure relates to a tremolo device for a guitar.

### BACKGROUND OF THE INVENTION

It has long been known to equip guitars and other stringed musical instruments with a tremolo device. The tremolo device enables the instrument player to change the tension in the strings when desired, and thereby simultaneously create a pitch change during vibration of the strings. Typically, such tremolo devices include a moving piece on the body of the stringed instrument that is used to accomplish the tension change in the strings. In such a device, a pivot point is established, and the moving piece pivots about that point to vary the tension in the strings. A counter-spring is generally used to counteract the pull of the strings on the moving piece. A lever or actuating arm is generally provided for facilitating the pivoting of the moving piece, while simultaneously playing the instrument.

U.S. Pat. No. 2,741,146 discloses a tremolo device for use with a guitar. The tremolo device comprises a base plate attached to a bar that extends within a cavity in the body of the guitar. The bar is attached at its lower end by springs to an anchor within the cavity. A leading edge of the base plate is beveled to form a fulcrum ridge, and the plate is loosely attached to the guitar body using a plurality of screws linearly disposed along the fulcrum ridge. With this arrangement, the base plate may pivot about the fulcrum defined by the screws. A lever arm is attached to one side of the base plate. As a player presses down on the lever arm the spring-biased base plate pivots forward, stretching the springs, and reducing the string tension causing the pitch of the guitar strings to decrease or “go flat.” When the player releases the lever arm, the base plate returns to a neutral position or “in-tune” state due to the biasing effect of springs that counteract the tension of the guitar strings attached to the bridge.

Modifications of a tremolo device are described in U.S. Pat. No. 4,171,661, U.S. Pat. No. 4,632,004, U.S. Pat. No. 4,903,568, U.S. Pat. No. 5,088,374, or U.S. Pat. No. 6,300,550, and include a base plate having two knife-shaped regions located on either side, and typically along the leading edge, of a base plate. Each knife-shaped edge region registers against a screw or pin set into the upper surface of the guitar body. The contact area between the knife shaped edge and pin is small permitting easy movement of the tremolo device when in use. However, as the contact area is small, both surfaces are subject to wear during use as the tremolo device is pivoted back and forth. As the bearing surfaces dull, friction increases, leading to less than ideal performance in that the tremolo base plate does not consistently return to the precise “in-tune” position at rest.

U.S. Pat. No. 6,015,945 discloses a leading edge of a base plate that is curved (a rocker element) and contacts two pins positioned on either side of a base plate, each pin having an approximate “I beam” cross-section defining three contact surfaces. The three contact surfaces comprise two confining surface portions that may be planar or convex located above and below, and spaced apart by, a planar bearing surface that is oriented essentially perpendicular to the curved leading edge of the base plate. The three surfaces of the pin ensures that the contact between the curved leading edge of the base plate and the pin occurs at one (when contacting the bearing surface) or two (when contacting the bearing surface and one of the confining surfaces) contact points.

The configuration of many of the prior art designs are such that when in place and in a neutral position, the bottom surface of the base plate typically floats above the top surface of the guitar. This configuration may lead to a neutral position that is not always in-tune as the base plate may move above or below a plane parallel to the top surface of the guitar, and produce a flat sound.

WO2011/100828 discloses a tremolo device comprising a base plate with a leading edge that defines a bearing surface. The bearing surface engages with a pivot rail at its outer bearing surface (pivot bearing surface), with the pivot rail mounted to an upper surface of a stringed instrument using screws or other fasteners. The bearing surface of the leading edge is matingly engaged with the pivot bearing surface of the pivot rail such that three or more contact surfaces between the bearing surface and the pivot bearing surface are defined, with the contact surfaces having a length of from about 20% to about 100% of the length of the leading edge. A lever, attached to or integral to the base plate, is used to rotate the base plate about the pivot rail to alter the tension on the strings and thereby create a vibrato sound. Rotational movement and axial movement of the base plate along the length of the pivot rail, when moved about the pivot rail, is limited by having pins located on the pivot rail that register within complementary slots, slotted apertures or cavities within the bearing surface of the base plate. The pins and slots are positioned perpendicular to the length of the pivot bearing surface and the leading edge, respectively. Alternatively, axial movement of the base plate along the length of the pivot rail may be limited by having portions of the leading edge abut against portions of the pivot rail when engaged.

The tremolo device of WO2011/100828 provides a large contact surface area between the base plate and the pivot rail. Wear between these two surfaces is, therefore, reduced, while sound transfer is enhanced. By having the base plate, or a portion of the base plate, to lie on top of a stringed instrument when in the “neutral” position, the stringed instrument is kept in-tune when the tremolo device is not activated.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

The present disclosure relates to a tremolo device for a stringed instrument. More particularly, the disclosure relates to a tremolo device for a guitar.

It is an object of the invention to provide an improved tremolo device.

A tremolo device is provided that comprises,

a base plate, the base plate comprising a bracket for attachment of a lever, and a leading edge comprising an elongate bearing surface, the elongate bearing surface defining an engagement end at a first end of the elongate bearing surface, and a lever end at a second end of the elongate bearing surface, the lever end being located near the bracket, and

a pivot rail comprising an elongate pivot bearing surface with a mating end at one end, so that when the base plate is engaged with the pivot rail, the engagement end of the elongate bearing surface is matingly engaged with the mating end of the pivot rail, to secure pivotal contact between the bearing surface and the pivot bearing surface preventing separation of the engagement end of the base plate from the mating end of the pivot rail while allowing rotation of the base plate about a longitudinal axis of the pivot rail.

As described herein, the mating end of the tremolo device may comprise a pin aligned along the longitudinal axis of the pivot rail and extending out from the end of the mating end, and the engagement end may comprise a recess for matingly receiving the pin. Alternatively, the mating end may comprise a surface that defines a recess aligned along the longitudinal axis of the pivot rail, and the engagement end comprise a pin for pivotally engaging the mating end.

In another variation, the mating end the tremolo device as described above may comprise a surface that defines a recess aligned along the longitudinal axis of the pivot rail, the engagement end may comprise an end wall defining a second recess, the mating end and the engagement end pivotally engaged with a pin that is fit into the mating end and the end wall of the engagement end.

In another variation, the mating end defines a threaded recess aligned along the longitudinal axis of the pivot rail, and the engagement end comprises the end wall defining the second recess, the mating end and the engagement end are pivotally engaged with a pin threaded into the mating end and pivotally fit into the end wall of the engagement end. In an additional variant, the mating end defines a recess aligned along the longitudinal axis of the pivot rail, and the engagement end comprises the end wall defining a threaded recess, the mating end and the engagement end pivotally engaged with a threaded pin that is threaded into the end wall of the engagement end and pivotally fit into the mating end.

The leading edge of the tremolo device as described above may terminate in a beveled edge to permit rotation of the base plate about a longitudinal axis of the pivot rail.

Additionally, the pivot rail of the tremolo device described above may further comprises one or two pins located on an upper surface of the pivot rail, perpendicular to the longitudinal axis of the pivot rail, and the leading edge comprising one or two corresponding slots to receive the one or two pins when the base plate is mounted on the pivot rail. The tremolo device may further comprise a lever is attached to the bracket.

As described herein, a tremolo device is provided that ensures that the baseplate and pivot rail remain pivotally engaged when the lever is actuated in any direction, or if the lever is actuated strongly.

This summary of the invention does not necessarily describe all features of the invention. Other aspects, features and advantages of the present disclosure will become apparent to those of ordinary skill in the art upon review of the following description of specific embodiments of the invention.

### BRIEF DESCRIPTION OF THE DRAWINGS

These and other features of the invention will become more apparent in the following detailed description in which reference is made to the appended drawings.

FIG. 1 shows an exploded perspective view of a prior art tremolo device as described in WO2011/100828 (which is incorporated herein by reference).

FIG. 2A shows a bottom plan view of a base plate and pivot rail. The base plate is separate from the pivot rail. FIG. 2B shows an enlarged fragmentary bottom perspective view of the engagement end of the base plate and the mating end of the pivot rail of the tremolo device assembled together. The example of a tremolo device shown in FIGS. 2A and 2B is shown in a right-handed orientation. As would be readily understood, this device may also be used in a left-handed orientation with the appropriate re-arrangement of the elements.

FIG. 3A shows a top plan view of the pivot rail of the tremolo device shown in FIGS. 2A and 2B. FIG. 3B shows a side elevational view of the pivot rail of the tremolo device of FIG. 3A. FIG. 3C shows an enlarged fragmentary top plan view of the pivot rail of FIG. 3A, showing a pin at an engagement end of the pivot rail. FIG. 3D shows a perspective view of the pivot rail of FIG. 3A.

FIG. 4A shows a bottom plan view of a base plate and the pivot rail assembled together, with a pin at a mating end of the pivot rail matingly engaged with an open slotted aperture at an engagement end of the base plate. FIG. 4B shows an enlarged fragmentary bottom perspective view of the pin of the pivot rail matingly engaged with the open slotted aperture of the base plate, as shown in FIG. 4A. FIG. 4C shows a cross-sectional perspective view of the base plate and the pivot rail of FIG. 4A, taken along line C-C of FIG. 4A. The example of a tremolo device shown in FIGS. 4A, 4B and 4C is shown in a right-handed orientation. As would be readily understood, this device may also be used in a left-handed orientation with the appropriate re-arrangement of the elements.

FIG. 5A shows a bottom plan view of a base plate and the pivot rail assembled together, with a pin at a mating end of the pivot rail matingly engaged with a closed slotted aperture at an engagement end of the base plate. FIG. 5B shows a cross-sectional view of the base plate and the pivot rail of FIG. 5A, taken along line B-B of FIG. 5A. The example of a tremolo device shown in FIGS. 5A and 5B is shown in a right-handed orientation. As would be readily understood, this device may also be used in a left-handed orientation with the appropriate re-arrangement of the elements.

FIG. 6 shows a bottom perspective view of an alternate example of a base plate separate from a pivot rail of a tremolo device of the present disclosure, shown in a right-handed orientation with a pin at an engagement end of the base plate for mating engagement with a recess at a mating end of the pivot rail.

FIG. 7A shows a bottom plan view of the-base plate of FIG. 6, with the pin at the engagement end of the base plate for mating engagement with a recess of the pivot rail. FIG. 7B shows a cross-sectional view of the base plate of FIG. 7A, taken along line B-B of FIG. 7A. FIG. 7C shows an enlarged fragmentary bottom perspective view of the pin of the base plate of FIG. 7A. FIG. 7D shows a bottom perspective view the base plate of FIG. 7A.

FIG. 8 shows an enlarged bottom perspective view of an alternate example of a base plate separate from a pivot rail of a tremolo device of the present disclosure, shown in a right-handed orientation with a pin passed through a hole or aperture at an engagement end of the base plate for mating engagement with a recess at a mating end of the pivot rail. As would be readily understood, this device may also be used in a left-handed orientation with the appropriate re-arrangement of the elements.

FIG. 9A shows a bottom plan view of the base plate assembled together with the pivot rail of FIG. 8. FIG. 9B shows a cross-sectional view of the base plate of FIG. 9A, taken along line B-B of FIG. 9A. FIG. 9C shows an enlarged fragmentary cross sectional view of the engagement end of the base plate of FIG. 9A with a pin inserted in the hole or aperture. FIG. 9D shows a bottom perspective view of the base plate of FIG. 9A, with a hole or aperture through the thickness of the engagement end of the base plate for receiving a pin for mating engagement with the recess of the pivot rail. The example of a tremolo device shown in FIGS. 9A, 9B, 9C and 9D is shown in a right-handed orientation. As would be readily understood, this device may also be used in a left-handed orientation with the appropriate re-arrangement of the elements.

FIG. 10A shows a top plan view of the pivot rail of either FIG. 6 or FIG. 8. FIG. 10B shows a cross-sectional view of the pivot rail of FIG. 10A, taken along like B-B of FIG. 10A. FIG. 10C is an end-on view of the pivot rail of FIG. 10A depicting the recess of the pivot rail for matingly engaging with the pin of the base plate of either FIG. 6 or FIG. 8. FIG. 10D is a perspective view of the pivot rail of FIG. 10A.

### DETAILED DESCRIPTION

The present disclosure relates to a tremolo device for a stringed instrument. More particularly, the present disclosure relates to a tremolo device for a guitar.

The following description is of a preferred embodiment.

Directional terms such as “top”, “bottom”, “left”, “right”, “horizontal”, “vertical”, “transverse” and “longitudinal” are used in this description merely to assist the reader to understand the described embodiments and are not to be construed to limit the orientation of any described method, product, apparatus or parts thereof, whether in operation or in connection to another object.

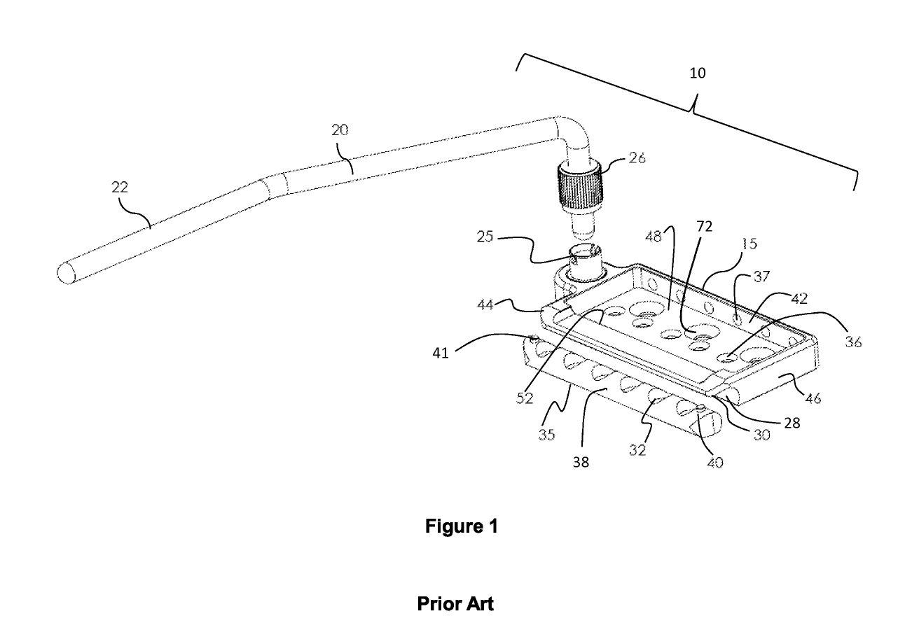

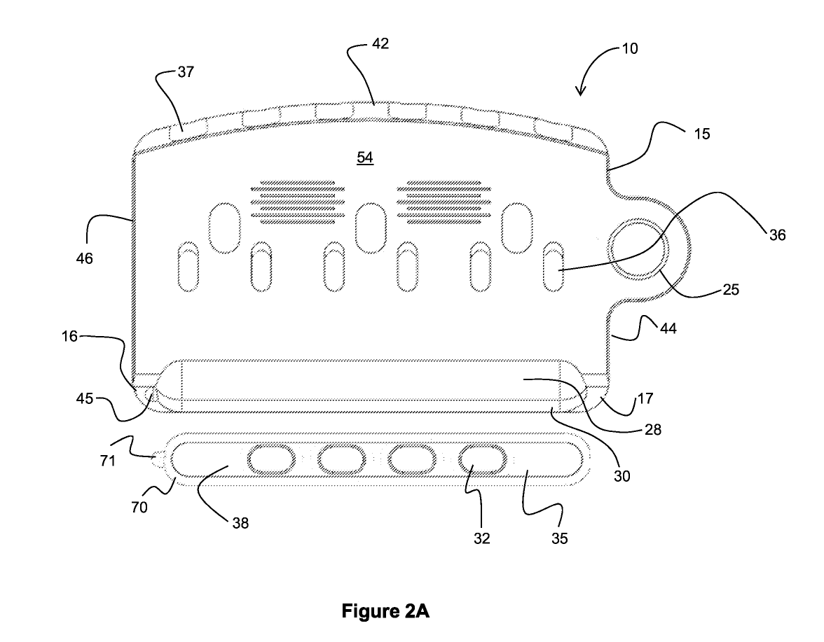

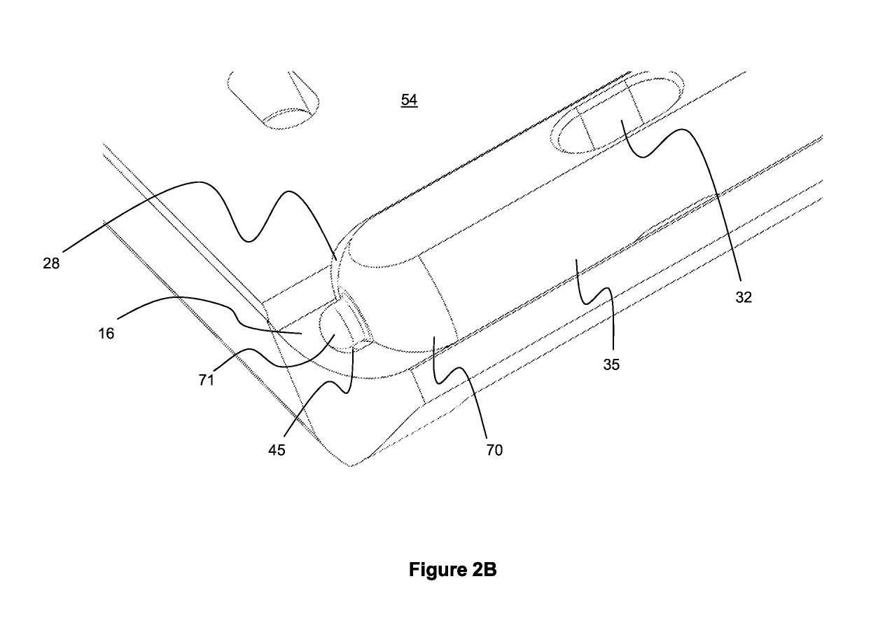

FIG. 1 provides a prior art tremolo device described in WO2011/100828 (which is incorporated herein by reference). The tremolo device 10 comprises a base plate 15 and a pivot rail 35. The pivot rail 35 has an outer bearing surface or elongate pivot bearing surface 38 and may be mounted to an upper surface of a stringed instrument, such as a guitar, using screws or other fasteners via holes 32. The base plate 15 has a leading edge 30 defining a bearing surface (also termed an elongate bearing surface) 28 and a back end 42, opposed sides 44 and 46, and a surface 48. The base plate is attached to a bar (not shown; see 25 in FIG. 2 of WO2011/100828) via holes 72. The bar extends within a cavity in the body of the guitar, and the bar is attached to the guitar body at its lower end by one or more springs to an anchor the bar within the cavity.

The sides 44, 46, back end 42, and inside surface 52 of the leading edge 30 of the base plate are raised to form side, back and front walls, respectively, of the base plate 15. The leading edge 30 extends laterally outward such that the elongate bearing surface 28 of the base plate 15 is in contact with the elongate pivot bearing surface 38 of the pivot rail 35 when the pivot rail is mounted on the stringed instrument. Strings, when installed on the stringed instrument, pass through apertures 36 provided in the bottom surface 48 of the base plate 15. Holes 37 may be used to fit conventional adjusters connected to a bridge (not shown).

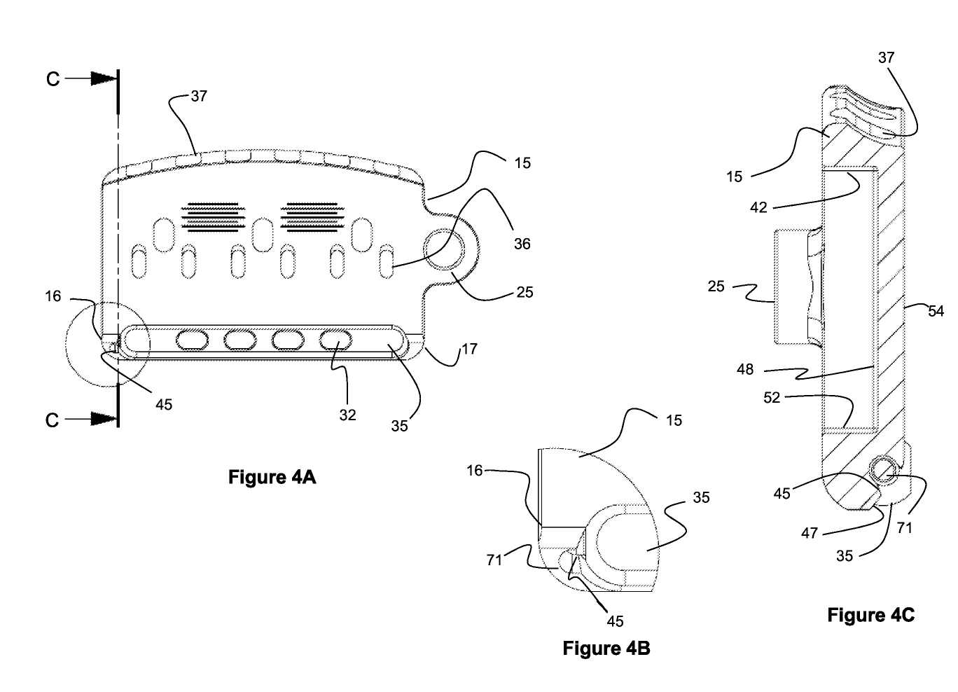

The prior art tremolo device as shown in FIG. 1 is characterized as having an increased surface area between the base plate and the pivot rail. The base plate lies on the top surface of the body of the stringed instrument when in a “neutral” position. By locating the base plate, or a portion of the base plate, to lie on top of a stringed instrument when in the “neutral” position, the stringed instrument is kept in-tune when the tremolo device is not activated. The ends of the leading edge 30 are open along sides 44 and 46. Therefore, to maintain the in-tune, neutral position, base plate 15 registers with the pivot rail 35 using pins 40 and 41. Pins 40 and 41 interact with complementary slots located in elongate bearing surface 28 of the leading edge 30 of base plate 15 (the complimentary slots are not shown in FIG. 1; see FIG. 4F of WO2011/100828; slot 50). When the pivot rail is mounted on the guitar body, pins 40 and 41 are positioned on the upper surface of the elongate pivot bearing surface so that they are perpendicular relative to the length of the elongate pivot bearing surface 38. Similarly, when the base plate 15 is mounted to the bar and positioned on the guitar surface body, the complementary slots are positioned within the elongate bearing surface 28 of the leading edge 30 so that they receive pins 40 and 41.

With the positioning of pins 40 and 41 on the upper surface of the elongate pivot bearing surface 38 and corresponding slots within the elongate bearing surface 28 of the leading edge 30, the base plate 15 may dislocate from the pivot rail 35 during use, when the lever 20 of the tremolo device 10 is strongly actuated, or actuated in a direction that extends away from the base plate 15. For example, when lever 20 is strongly pressed towards the guitar body, the torque applied to the bracket 25 may lift side 46 (i.e. the side of the base plate 15 opposite to where lever 20 is attached) of base plate 15 up and off the pivot rail 35. In this situation, the slot within the elongate bearing surface 28 of the base plate 15 may disengage from pin 40 (i.e. the pin that is positioned near side 46 of the base plate 15). When lever 20 is released and base plate 15 comes to its rest (or neutral) position, the slot within elongate bearing surface 28 of base plate 15 that is adjacent to side 46 may not register with pin 40 of the pivot rail 35 and the base plate 15 may remain partially disengaged with pivot rail 35. The disengagement of the base plate 15 and pivot rail 35 may result in the strings being out-of-tune when the base plate 15 returns to the neutral position. Furthermore, separation of the base plate 15 from the pivot rail 35 may reduce the sound quality of the tremolo device 10 as the contact area between the leading edge 30 and the elongate pivot bearing surface 38 is reduced. Having the base plate 15 separate from the pivot rail 35 may also disrupt the instrument player during a musical performance as the base plate 15 would need to be re-aligned with the pivot rail 35. Disengagement of the base plate 15 from the pivot rail 35 would be reduced if the lever 20 is actuated in a direction that extends over the base plate 15. However, to accommodate a variety of playing styles of a performer, the base plate 15 and pivot rail 35 need to remain engaged when the lever 20 is actuated in any direction, or if the lever 20 is actuated strongly.

The present disclosure relates generally to a tremolo device for a stringed instrument that addresses the above identified problem.

As used herein, the term “leading edge” means the edge of the base plate that extends the length of the base plate, typically from one side of the base plate comprising the lever end to the opposite side of the base plate comprising the engagement end. The leading edge defines a bearing surface or an elongate bearing surface which contacts the elongate pivot bearing surface of the pivot rail when the tremolo device is assembled.

As used herein, the term “pivot bearing surface” or “elongate pivot bearing surface” means the surface of the pivot rail that extends a length of the pivot rail, typically from one side of the pivot rail comprising the mating end to the opposite side of the pivot rail, and is the surface that contacts the elongate bearing surface of the base plate when the tremolo device is assembled.

As used herein, the term “matingly engages,” “matingly engageable” or “mating engagement” means that the engagement end of the base plate is in contact with and connected with the mating end of the pivot rail such that the base plate is secured to the pivot rail, while still allowing the base plate to pivot or rock about the pivot rail by actuation of the lever attached to the base plate.

As used herein, the term “contact” with respect to “contact” between the elongate bearing surface of the base plate and elongate pivot bearing surface of the pivot rail means that the elongate pivot bearing surface and the elongate bearing surface of the leading edge are physically in contact along a substantial percentage of the length of the leading edge, for example, about 20% to about 100%, or any amount therebetween, of the length of the leading edge, or from about 20, 22, 24, 25, 26, 28, 30, 32, 34, 36, 38, 40, 42, 44, 46, 48, 50, 52, 54, 56, 68, 60, 62, 64, 66, 68, 70, 72, 74, 75, 76, 78, 80, 82, 84, 86, 88, 90, 92, 94, 96, 98, 100%, or any amount therebetween, of the length of the leading edge. Without wishing to be bound by theory, an increased percentage of contact between the bearing surface of the leading edge and the pivot bearing surface of the pivot rail reduces the force per unit area between these two surfaces when in use, decreasing wear, and maximizing the transmission of vibrational energy, and sound transfer, from the bridge (located on the base plate when in use) to the guitar body through the pivot rail (as described in CA 2,693,684), when compared to prior art configurations that use a leading edge with two knife-shaped, or curved regions, engaging two pins, as shown in U.S. Pat. No. 4,171,661, U.S. Pat. No. 4,903,568, U.S. Pat. No. 5,088,374, U.S. Pat. No. 6,015,945, and U.S. Pat. No. 6,300,550.

As described herein, a tremolo device 10 is provided that ensures that the base plate 15 and pivot rail 35 remain pivotally engaged when a lever 20 is actuated in any direction, or if the lever 20 is actuated strongly. With reference to FIGS. 1-10, generally, the tremolo device 10 comprises a base plate 15, the base plate comprises a bracket 25 for attachment of a lever 20, and a leading edge 30. The ends of the leading edge 30 are “closed” along sides 44 and 46. That is, the leading edge 30 comprises an elongate bearing surface 28 with an engagement end 16 at a first end of the elongate bearing surface 28, and a lever (free) end 17 at a second end of the elongate bearing surface 28, the free or lever end 17 being located near the bracket 25. The tremolo device 10 also includes a pivot rail 35 comprising an elongate pivot bearing surface 38 with a mating end 70 at one end. When the base plate 15 is engaged with the pivot rail 15, the engagement end 16 of the elongate bearing surface 28 is matingly engaged with the mating end 70 of the pivot rail 35, and this pivotally secures contact between the elongate bearing surface 28 of the leading edge 30 and the elongate pivot bearing surface 38 of the pivot rail, to allow rotation of the base plate 15 about a longitudinal axis of the pivot rail 35, when the base plate is actuated by lever 20. FIGS. 1-10 depict alternative embodiments of the tremolo device of the present disclosure in a right-handed orientation (that is, with the various elements of the tremolo device secured together and mounted on a stringed instrument in an orientation that enables a right-handed user to play the stringed instrument). It is to be understood, however, that the tremolo device of the present disclosure may also be configured in a left-handed orientation, with the various elements of the tremolo device being adjusted accordingly, for example as a mirror image of those shown in FIGS. 1-10, to enable a left-handed user to use the tremolo device on a stringed instrument.

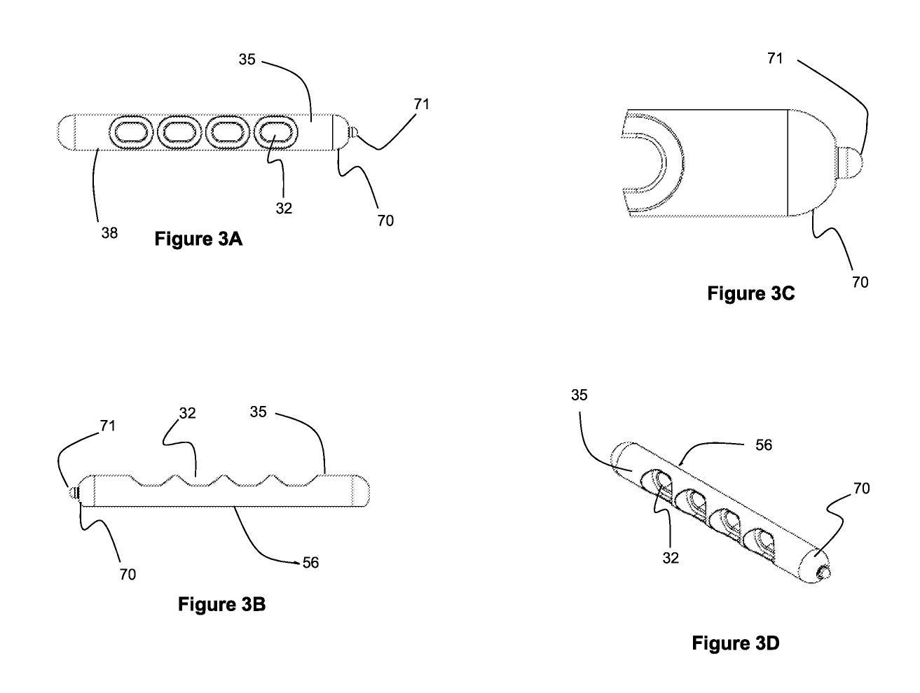

An example of a tremolo device 10 of the present disclosure is provided in FIGS. 2A and 2B. FIG. 2A shows the tremolo device 10 comprising the elongate pivot rail 35 disassembled from the base plate 15. An outside bottom surface 54 of the base plate 15 is shown, which would lie against the top surface of the body of a stringed instrument (not shown). The pivot rail 35 has an outer bearing surface 38, (which may also be referred to as a pivot bearing surface or elongate pivot bearing surface), and a mating end 70, and may be mounted to an upper surface of a stringed instrument, such as a guitar, using screws or other fasteners via holes 32 (see FIGS. 3A, 3B, 3C and 3D).

The base plate 15 has a leading edge 30 defining an elongate bearing surface 28 (or bearing surface) and a back end 42, opposed sides 44 and 46, and a bottom surface 48 (the bottom surface 48 is not shown in FIG. 2A). The sides 44, 46, and back end 42 and inside surface 52 (not shown in FIG. 2A or 2B) of the leading edge 30 of the base plate are raised to form side, back and front walls, respectively. The leading edge 30 comprises “closed” ends 16 and 17 (that is, engagement end 16 and lever end 17), and the leading edge 30 extends laterally outward such that the bearing surface 28 of the base plate 15 is in contact with the pivot bearing surface 38 of the pivot rail 35 when the pivot rail is mounted to the stringed instrument. The leading edge 30 of the base plate 15, therefore, comprises an engagement end 16 and a lever (free) end 17. Strings, when installed on the stringed instrument, pass through apertures 36 provided in the bottom surface 48 of the base plate 15. Holes 37 may be used to fit conventional adjusters connected to the bridge.

In the example shown in FIGS. 2A and 2B, the mating end 70 comprises a pin 71 extending out along the longitudinal axis of the pivot rail 35, from mating end 70. Mating end 70 registers with the engagement end 16 of the base plate 15 as shown in FIG. 2B. The engagement end 16 comprises a suitably shaped receptor to receive and “lock” mating end 70 with engagement end 16, while still permitting rotation of base plate about the pivot rail. In the example shown in FIGS. 2A and 2B, pin 71 of the pivot rail 35 matingly engages a slotted aperture 45 of the engagement end 16. As described below, this mating engagement secures pivotal contact between the bearing surface 28 of the base plate 15 and the pivot bearing surface 38 of the pivot rail 35 while the tremolo device is in use. By registering pin 71 within slotted aperture 45, the base plate 15 remains engaged with the pivot rail 35 when lever 20 is actuated in a variety of directions or when it is strongly actuated, and ensures that the engagement end 16 of base plate 15 does not lift off of, or separate from, pivot rail 35.

A lever 20 may be mounted to a bracket 25 that is disposed at the side 44 of the base plate 15 which has the lever (free) end 17 in a manner as shown in FIG. 1. The lever 20 may be mounted to the bracket 25, for example, by threading the lever 20, or a coupler 26 fitted to the lever 20, to a correspondingly threaded bracket 25, or the lever 20, or coupler 26, may have one or more pins that engage with a bracket having one or more slots or recesses to engage the pins, thereby permitting removal of the lever. Alternatively, the lever may be fixed and comprise an integral part of the base plate 15. The lever 20 is attached so that in use the arm 22 projects upward and away from the body of the stringed instrument.

A tremolo effect is achieved by pivoting or rocking the base plate 15 about the pivot rail 35 by actuation of lever 20 attached to the base plate 15 by bracket 25. When the base plate 15 rotates forward about a fulcrum having a center of axis defined by the pivot rail 35, this causes the strings to reduce in tension, while at the same time stretching one or more than one spring attached to the bar within the cavity of the guitar body (see FIG. 2 of WO2011/100828). The base plate 15 returns to the neutral or “in tune” position when the lever 20 is released through the counteraction of the one or more than one spring.

The mating engagement of the base plate 15 to the pivot rail 35 at the engagement end 16 and the mating end 70, respectively, secures contact between the bearing surface 28 and the pivot bearing surface 38 along the length of the leading edge 30 while still allowing the base plate 15 to pivot about pivot rail 35 when lever 20 is activated. Following activation of the lever 20, the mating engagement of the engagement end 16 of base plate 15 to the mating end 70 of the pivot rail 35 ensures that contact between the elongate bearing surface 28 and the pivot bearing surface 38 remains intact and the base plate is returned to an in-tune, “neutral,” position.

With reference to FIG. 3B, it can be seen that the pivot rail 35 may comprise a flat bottom surface 56 so that it sits flush when attached to the top surface of a stringed instrument (not shown) via holes 32. However, the pivot rail 35 may also have other cross-sectional shapes, for example, it may be circular, oval, square, rectangular, triangular, pentagonal, hexagonal, or octagonal, in cross-section, provided that it can be attached to the surface of the stringed instrument using holes 32 and provide a contact surface 38 to engage with elongate bearing surface 28 of base plate 15.

FIG. 2B shows an enlarged fragmentary bottom perspective view of a portion of the outside bottom surface 54 of the base plate 15 and the pivot rail 35 when assembled together. In this example, the engagement end 16 of the base plate 15 matingly engages the mating end 70 of the pivot rail 35 using a pin, or registration pin, 71 at mating end 70. The registration pin 71 matingly engages the engagement end 16 of the base plate 15 via a slotted aperture 45 within the engagement end 16 of the base plate 15.

Engagement of the base plate 15 with the pivot rail 35 is achieved by registering the pin 71 within the slotted aperture 45 of the base plate while the engagement end 16 is matingly engaged with the mating end 70 and the mating end 70 abuts against the engagement end 16 of the base plate. This registration limits dislocation of the engagement end 16 from the mating end when the lever 20 is forcefully and repeatedly actuated downwards towards and upwards away the body of the stringed instrument.

It is to be understood that, if desired, the base plate 15 and pivot rail 35 may further comprise pins 40 and 41 (FIG. 1) and corresponding slots as described in WO2011/100828 to limit rotational movement of the base plate 15 as it pivots about pivot rail 35.

FIGS. 3A, 3B, 3C, and 3D show pivot rail 35 comprising the registration pin 71 at the mating end 70 in different views. The registration pin 71 extends longitudinally outward from the mating end 70 in order to matingly engage the engagement end 16 of the base plate 15. The registration pin 71 may be of any shape so long as it can engage with a correspondingly shaped slotted aperture 45 or other suitably shaped receptor so that the base plate 15 is pivotally secured to the pivot rail 35. For example, without limitation, registration pin 71 may be circular, square, rectangular, triangular, pentagonal, hexagonal, octagonal, or any shape that works with the slotted aperture 45 or other suitably shaped receptor.

The registration pin 71 may be any type of pin for mating engagement with the slotted aperture 45, for example, without limitation, registration pin 71 may be a spring-loaded pin that may be pressed into the body of the pivot rail 35 and extend outwards into slotted aperture 45, a solid-shaped pin, such as a solid cylindrical pin, a solid tapered pin, for example mating end 70 may be of a conical shape, with the end or tip of the conically shaped end registering with slotted aperture 45, or a hollow pin. The registration pin 71 may also be made of the same material as the pivot rail, or it may be made from, for example, stainless steel, an alloy, a metal alloy, polypropylene and ceramic and attached to the pivot rail, or pin 71 may be made an integral part of the pivot rail 35 during manufacture. If pin 71 is a spring loaded pin that can be pressed into a cavity within the pivot rail, then both ends of the pivot rail may comprise a pin extending from the ends of the pivot rail. Alternatively, the pivot rail may comprise two pins, one at each end, with the end, opposite to the mating end 70, of the pivot rail comprising a spring-loaded pin, and the mating end comprise a fixed pin. By providing one pin as a spring-loaded pin, engagement of the base plate 15 with the pivot rail 35 would still be possible, while ensuring that pin 71 is in proper registration with slotted aperture 45.

When assembling the base plate 15 onto pivot rail 35 that is attached to a guitar body, there is minimal space available, either axially along the length of the leading edge 30 of base plate 15 and pivot rail 35, or in a direction that is perpendicular to the pivot rail 35 and along the plane of the base plate 15 (i.e., along the surface of the guitar body). Accordingly, registration pin 71 is designed to be relatively small in size, and may be for example between about 0.1 mm and about 5 mm in diameter, or any diameter therebetween, for example, about 2 mm to about 4 mm, or any diameter therebetween. Furthermore, the length of registration pin 71 that extends longitudinally outward from the mating end 70, particularly when the registration pin 40 is not a spring-loaded pin that can be compressed when assembling the base plate 15 on the pivot rail 35, is between about 0.2 mm to about 10 mm, or any length therebetween. For example, without limitation, the registration pin 40 may extend longitudinally outward from the mating end 70 by between about 1 mm to about 7 mm in length, or any length therebetween, or about 0.2, 0.3, 0.4, 0.5, 0.6, 0.8, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10 mm, or any length therebetween, from the end of mating end 70.

The slotted aperture 45 as shown in the examples presented in FIGS. 4A and 4B is an “open slot” configuration. That is, the slot extends to the lower side-edge of the engagement end 16 of the base plate 15 and the slot is open at the lower side-edge. In this configuration, in order for the pivot rail 35 to retain the base plate 15 in use, when the base plate 15 is actuated by the lever 20, the angle of the slot is selected so that there is negligible lifting movement of the base plate 15 from the surface of the guitar body. For example, the slot may have an angle of about 10 degrees to about 80 degrees or any angle therebetween, from vertical (when the base plate is placed on a horizontal surface, such as a guitar body, the vertical would be an imaginary line perpendicular to the plane of the base of the base plate). For example, the slot may be set at an angle of from 30 to 50 degrees from vertical, or any angle therebetween, for example 45 degrees, or the slot may be set with an angle of 10, 15, 20, 25, 30, 35, 40, 45, 50, 55, 60, 65, 70, 75, 80 degrees, or any angle therebetween, from vertical.

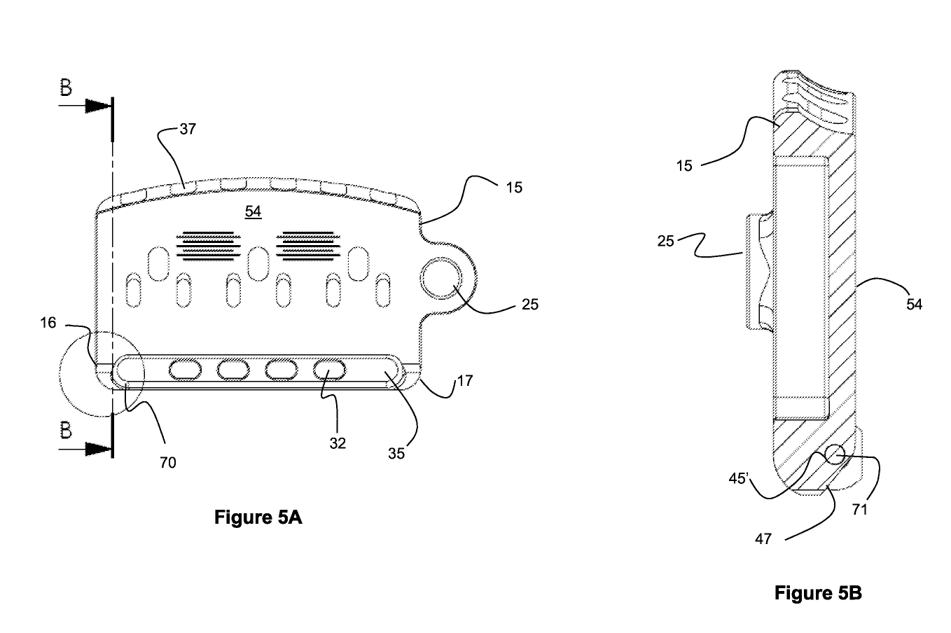

Alternatively, as shown in FIGS. 5A and 5B, the registration pin 71 can be matingly engaged within a “closed” aperture 45′ at the engagement end 16 of the base plate 15. The closed aperture 45′ and pin 71 are not visible in FIG. 5A since the opening of closed aperture 45′ is located within the engagement end 16 and the opening does not extend towards the lower side edge of the engagement end. In this configuration, when the base plate 15 is mounted onto the guitar to engage with pivot rail 35, pin 71 of the pivot rail is inserted into closed aperture 45′, and the free end 17 of the base plate is then slipped over the pivot rail 35. By ensuring that the length of the pivot rail 35 and the elongate bearing surface 28 are approximately the same, there is little side-to-side movement of base plate along the length of the pivot rail, thereby ensuring that the base plate is pivotally attached to the pivot rail when it is placed in position.

FIG. 4A shows a bottom plan view of the pivot rail 35 and the base plate 15 assembled together, with the pin 71 matingly engaged with the slotted aperture 45. As shown more clearly in FIGS. 4B and 4C, when assembled together, the pin 71 of the pivot rail registers with the open slotted aperture 45 of the base plate 15 such that the pin 71 fits within the slotted aperture 45. This mating engagement secures the bearing surface 28 of the base plate 15 in contact with the pivot bearing surface 38 of the pivot rail, while still allowing the bearing surface 28 to pivot or rotate about the pivot bearing surface 38 when the lever 20 is actuated. Therefore, separation of the base plate 15 from the pivot rail 35 is limited by having the pin 71 located at the mating end 70 of the pivot rail 35 and engaging with the engagement end 16. Axial movement of the base plate along the length of the pivot rail 35 is also limited by the pivot rail 35 abutting against the engagement end 16 of the base plate 15.

FIG. 4C illustrates the mating engagement of the slotted aperture 45 with the pin 71. The open slotted aperture 45 is sized to closely fit the registration pin 71 and secure the pivot rail 35 to the base plate 15. The open slotted aperture 45 extends at angle toward the bottom corner of the base plate 15 when the base plate 15 lies on top of the body of the stringed instrument. Accordingly, the open slotted aperture 45 is of a diameter and length similar to that of the length of the registration pin 71 to matingly engage the complementary registration pin 71 such that the base plate 15 is securely held together with the pivot rail 35 at the engagement end 16, while still permitting rotational movement of the base plate 15 when in contact with the pivot rail 35.

The leading edge 30 of the base plate 15 may further comprise a beveled edge 47 along its length to facilitate rotation of the base plate 15 about the pivot rail 35 during use. Further, beveled edge 47 may facilitate mounting of the base plate 15 to the pivot rail 35 and mating engagement of the engagement end 16 to the mating end 70. The above description of the open slotted aperture 45 is not meant to be limiting. Rather, the open slotted aperture 45 may be of any configuration and design that allows the engagement end 16 to matingly engage with the mating end 70 and permits rotational movement of the base plate 15 when engaged with the pivot rail 35.

FIGS. 5A and 5B illustrate a closed aperture 45′ for mating engagement with the pin 40 of the pivot rail 35. When assembled together, the pin 71 of the pivot rail 35 registers with the closed aperture 45′. This mating engagement secures the bearing surface 28 of the base plate 15 in contact with the pivot bearing surface 38 of the pivot rail 35, while still allowing the bearing surface 28 to pivot or rotate about the pivot bearing surface 38 when the lever 20 is actuated. Separation of the base plate 15 from the pivot rail 35 is, therefore, limited by having the pin 71 located at the mating end 70 of the pivot rail 35 and engaging with the engagement end 16. Axial movement of the base plate 15 along the length of the pivot rail 35 is also limited by the pivot rail 35 abutting against the engagement end 16 and free end 17 of the base plate 15.

The closed aperture 45′ is sized to closely fit the registration pin 71 and secure the pivot rail 35 to the base plate 15. As shown in FIG. 5B, the leading edge 30 may comprise a beveled surface 47 at the engagement end 16 to permit rotation of the base plate 15 about the pivot rail 35 during use. The closed aperture 45′ may be a recess defined within the engagement end 16 for receiving the pin 71, and not visible on the outer face of the engagement end 16. In order to matingly engage with the pin 71, the closed aperture 45′ is of a diameter and length similar to that of the complementary registration pin 71 while still permitting the base plate 15 to rotate about the pivot rail 35. The above description of the closed aperture 45′ is not meant to be limiting. Rather, the closed aperture 45′ may be of any configuration and design that allows the engagement end 16 to matingly engage with the mating end 70 and permits rotational movement of the base plate 15 when engaged with the pivot rail 35.

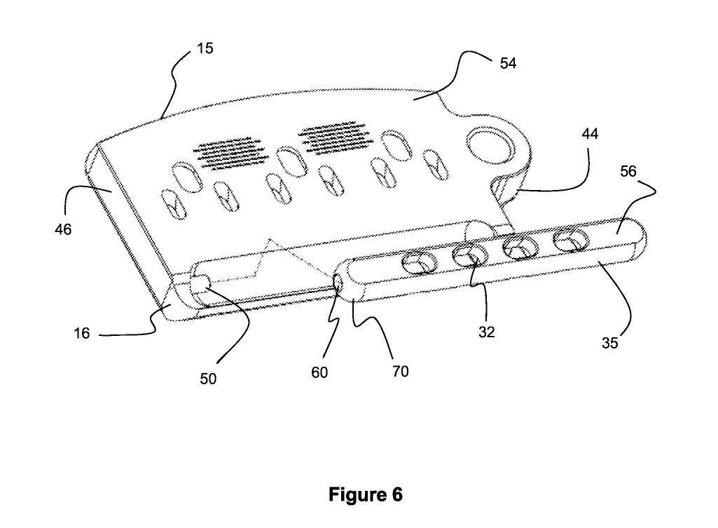

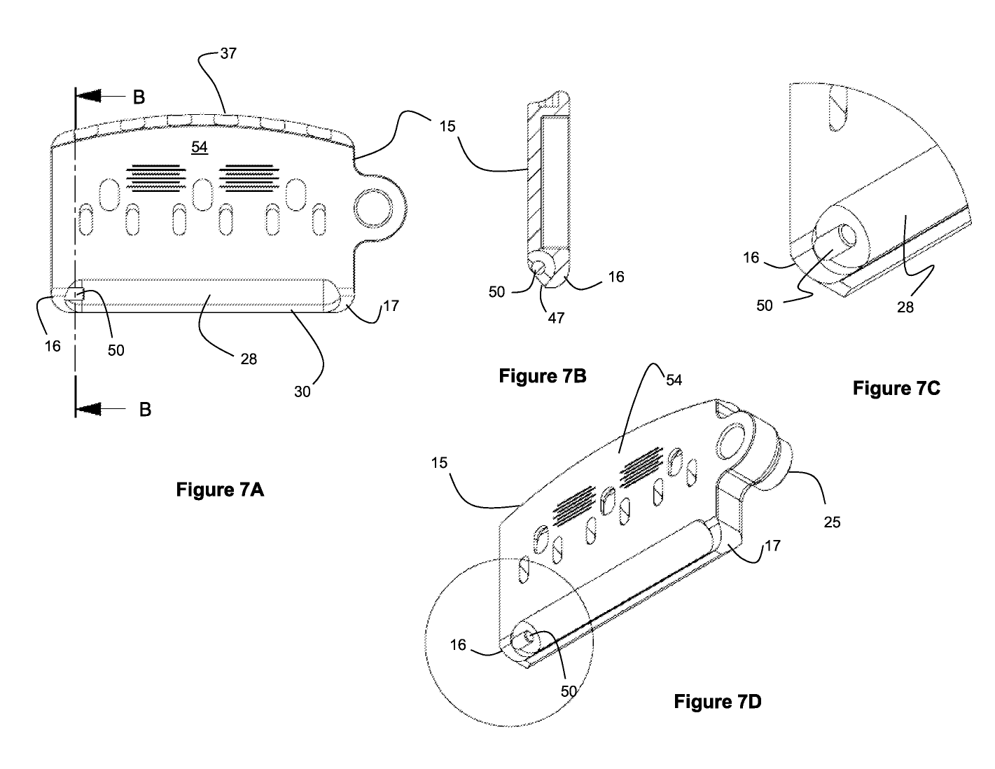

FIGS. 6 and 7 provide another example of a tremolo device 10 of the present disclosure. In this example, the tremolo device 10 comprises a base plate 15 having a registration pin 50 extending longitudinally out from the engagement end 16, and pivot rail 35 comprises a recess 60 to receive the registration pin 50. As shown in FIG. 6, the registration pin 50 may matingly engage with the recess 60 in the mating end 70 of the pivot rail 35 to secure the base plate 15 to the pivot rail 35 at the engagement end 16.

As shown in FIGS. 7A, 7C and 7D, registration pin 50 may be made an integral part of the base plate 15 at the engagement end 16 during manufacture, or may be attached to the engagement end 16, extending inwardly from the engagement end 16, after manufacture of the base plate 15. Registration pin 50 may be of any shape so long as it can engage with the recess 60 within the pivot rail 35 and secure the base plate 15 to the pivot rail 35. For example, without limitation, registration pin 50 may be circular, square, rectangular, triangular, pentagonal, hexagonal, octagonal, or any shape that works with the recess 60.

The registration pin 50 may be any type of pin for mating engagement with the recess 60, for example, without limitation, registration pin 50 may be a spring-loaded pin that may be pressed into the body of the base plate 15 (i.e., into the base plate 15 at engagement end 16) and extend outwards into the recess 60, a solid-shaped pin, such as a solid cylindrical pin, a solid tapered pin, for example, engagement end 16 may be of a conically shape, with the end or tip of the conically shaped end registering with corresponding recess 60, or a hollow pin. The registration pin 50 may also be made of any type of material, such as, for example, stainless steel, an alloy, a metal alloy, polypropylene or a rigid plastic polymer, and ceramic, and attached to the base plate 15. If pin 50 is a spring-loaded pin that can be pressed into a cavity within the engagement end 16 of the base plate 15, then both the engagement end 16 and the lever end 17 may comprise a pin extending from the ends of the leading edge 30. Alternatively, the leading edge 30 of the base plate 15 may comprise two pins, one at each of the engagement end 16 and the lever end 17, with either the engagement end 16 or the lever end 17 comprising a spring-loaded pin, and the opposite end comprising a fixed pin. By providing one pin as a spring-loaded pin, engagement of the base plate 15 with the pivot rail 35 would still be possible, while ensuring that pin 50 is in proper registration with recess 60.

Due to the space restrictions axially along the length of the leading edge 30 of the base plate 15 and perpendicularly along the plane of the base plate 15 and pivot rail 35, when mounting the base plate 15 on the pivot rail 35, registration pin 50 is designed to be, for example, between about 0.1 mm and about 5 mm in diameter, or any diameter therebetween, for example, about 2 mm to about 4 mm, or any diameter therebetween. Furthermore, the length of registration pin 50 that extends longitudinally outward from the inner wall of the engagement end 16, particularly when the registration pin 50 is not a spring-loaded pin that can be compressed when assembling the base plate 15 on the pivot rail 35, is between about 0.2 mm to about 10 mm, or any length therebetween. For example, without limitation, the registration pin 50 may extend longitudinally outward from the inner wall of the engagement end 16 by between about 1 mm to about 7 mm in length, or any length therebetween, or about 0.2, 0.3, 0.4, 0.5, 0.6, 0.8, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10 mm, or any length therebetween, from the inner wall of the engagement end 16. Such a size also enables rotational movement of the base plate 15 when engaged with the pivot rail 35, while securing the base plate 15 in contact with the pivot rail 35. As illustrated in FIG. 7B, the leading edge 30 of the base plate 15 may be beveled 47 to facilitate rotation of the base plate 15 about the pivot rail 35 during use, and facilitate mounting of the base plate 15 onto the pivot rail 35 and mating engagement of the engagement end 16 to the mating end 70.

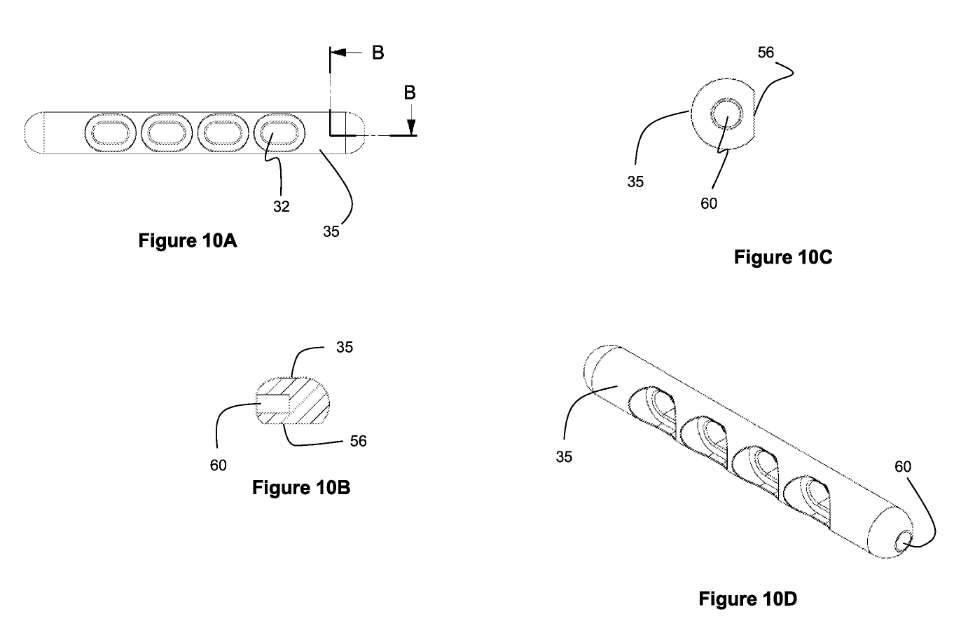

FIGS. 6 and 10 illustrate the recess 60 of the pivot rail 35. The recess 60 is positioned parallel to the length of the pivot rail 35 and extends longitudinally inward from the mating end 70 of the pivot rail 35 such that recess 60 can matingly engage registration pin 50. It is sized to closely fit around the registration pin 50 to secure the pivot rail 35 to the base plate 15, while still permitting rotational movement of the base plate 15 when engaged with the pivot rail 35. Accordingly, the recess 60 is of a diameter and length similar to that of the complementary registration pin 50, for example between about 0.1 mm and about 5 mm in diameter, or any diameter therebetween, for example, about 2 mm to about 4 mm, or any diameter therebetween. Furthermore, the length of pin 50 that extends longitudinally outward from the inner wall of the engagement end 16 is between about 0.2 mm to about 10 mm, or any length therebetween. For example, without limitation, the registration pin 50 may extend longitudinally outward from the inner wall of the engagement end 16 by between about 1 mm to about 7 mm in length, or any length therebetween, or about 0.2, 0.3, 0.4, 0.5, 0.6, 0.8, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10 mm, or any length therebetween, from the inner wall of the engagement end 16.

The above descriptions of recess 60 and pin 50 are not meant to be limiting. Rather, the recess 60 may be of any configuration and design that allows the engagement end 16 to matingly engage with the mating end 70 and permits rotational movement of the base plate 15 when engaged with the pivot rail 35. Accordingly, separation of the base plate 15 from the pivot rail 35 is limited by registering the pin 50 within the recess 60 and ensuring that the mating end 70 remains engaged with and abuts against the engagement end 16 of the base plate 15. Pin 50 and recess 60 are therefore designed and configured such that the registration of the pin 50 within the recess 60 limits axial movement of base plate 15 along the length of the pivot rail 35 and perpendicularly along the plane of the base plate 15, yet allows limited rotational motion of the base plate 15 with respect to the pivot rail 35 when the tremolo device is operated. It is to be understood that, if desired, the base plate 15 and pivot rail 35 may further comprise pins 40 and 41 and corresponding slots in the leading edge 30 as described in WO2011/100828 to further limit axial movement of the base plate 15 along the length of the pivot rail 35.

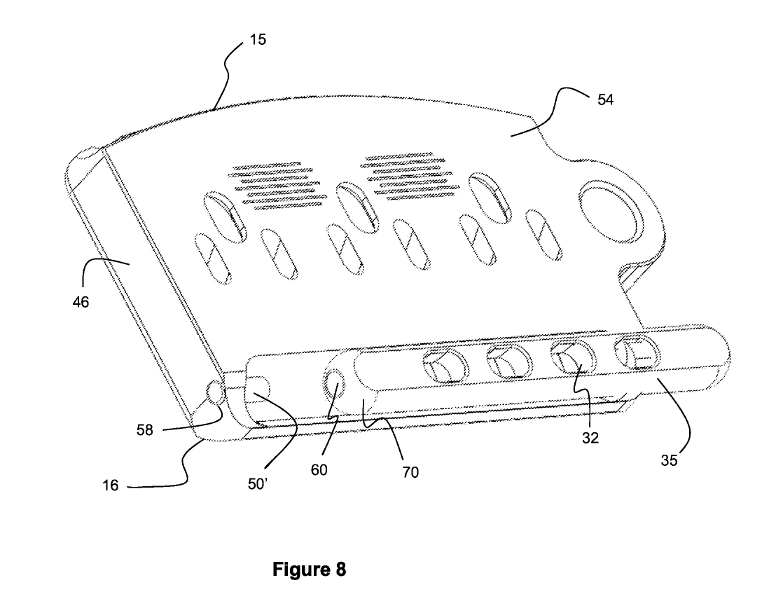

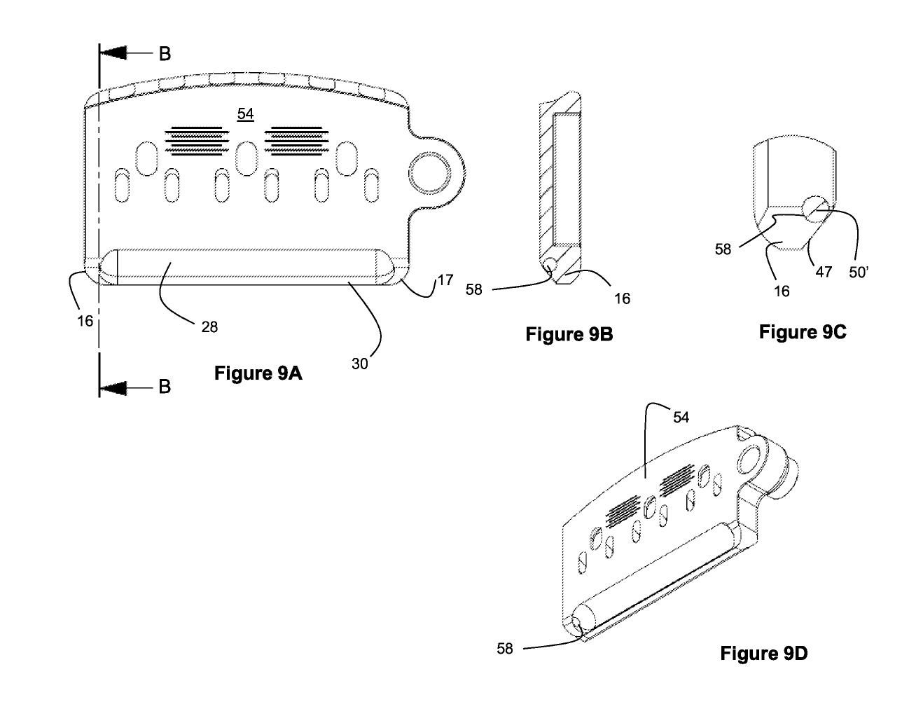

With reference to FIGS. 8 and 9, another variation of the tremolo device 10 of the present disclosure is provided. This example is similar to that shown in FIGS. 6 and 7, with the exception that a registration pin 50′ is inserted within an opening that spans the end wall of the engagement end 16 of the base plate. In this variation, the opening comprises a hole or aperture 58 drilled or molded into the wall of the engagement end 16 of the base plate 15 (see FIGS. 9B and 9D) such that the hole or aperture 58 passes through the thickness of the engagement end 16. The registration pin 50′ can then be inserted into the hole or aperture 58 for mating engagement with recess 60 of the pivot rail, in a similar manner to that described above (see FIG. 10). Registration pin 50′ may be press fit into recess 60, held in place with a key or C-clip, or the pin 50′ may be threaded, and the threaded pin screwed into recess 60 comprising corresponding threads. As illustrated in FIGS. 9B and 9C, the base plate 15 may be beveled 47 inward along the leading edge 30 to facilitate rotation of the base plate 15 when in use, and to assist with mounting of the base plate 15 onto the pivot rail 35 and matingly engaging the engagement end 16 to the mating end 70. This variant of the tremolo device 10 also has the property that separation of the base plate 15 from the pivot rail 35 is limited due to registering the pin 50′ within the recess 60. The mating engagement of the pin 50′ with the recess 60 ensures that the mating end 70 remains engaged with the engagement end 16 of the base plate 15 and abuts the mating end 70 against the engagement end 16 of the base plate 15. This mating engagement therefore secures contact between the base plate 15 and the pivot rail 35 and limits dislocation of the engagement end 16 from the mating end 70 when the lever 20 is forcefully actuated downwards towards and upwards away the body of the stringed instrument. Movement of the base plate 15 may also be limited in an axial direction along the length of the pivot rail, when moved about pivot rail 35, due to registration of the pin 50′ within the recess 60, yet rotational movement is still permitted. If desired, pivot rail 35 may further comprise pins 40 and 41, and base plate 15 comprise corresponding slots as described in WO2011/100828 to further limit rotational movement of the base plate 15 about the axis of pivot rail 35.

If desired, the tremolo device 10 of the present disclosure may also comprise a mating engagement between the base plate 15 and the pivot rail 35 at the lever end 17 of the base plate. Accordingly, any of the above variants for the pins (71, 50 and 50′) and the slotted aperture 45 or closed aperture 45′ or recess 60 may be used at the lever end 17 of the base plate. If two sets of pins are to be used, one at the engagement end 16 and a second at the lever end 17, then one or both of the pins may be a spring-loaded pin that either is received within a recess at one or both ends of the pivot rail or within a recesses in one or both of the end walls (either the engagement end wall or lever end wall) of the base plate, a separate pin 50′ that passes through one or both ends walls of the base plate (e.g. 58) may be used, a separate pin 50′ and a spring-loaded pin may be used in combination at either end of the pivot rail or at the engagement and lever ends of the base plate 15, or a combination of these may be used.

Furthermore, as described above, the tremolo device of the present disclosure may also comprise the elements used in the tremolo device of WO2011/100828 (which is incorporated herein by reference) to further mate the base plate 15 with the pivot rail 35 (such as, for example, the pins and slots, the pins and slotted apertures, the pins and cavities, and/or the rod-like sections and attachment portions).

It also to be understood that the base plate and the pivot rail as described herein may be attached to an analogous mechanism, for example as described in U.S. Pat. No. 4,171,661, U.S. Pat. No. 4,903,568, U.S. Pat. No. 4,984,493, U.S. Pat. No. 5,088,374, U.S. Pat. No. 6,015,945, U.S. Pat. No. 6,300,550 which are incorporated herein by reference. These prior art devices may be retrofitted as required, to permit mounting and movement of the base plate about the pivot rail as described herein.

Moreover, as described above, the tremolo device of the present disclosure may be configured in a right-handed orientation or a left-handed orientation, with the two variations being the same, with the exception of the various elements of the tremolo device being mirror images of each other.

The disclosures of all patents, patent applications and publications referenced in this specification are hereby specifically incorporated by reference in their entirety to the same extent as if each such individual patent, patent application, and publication were specifically and individually indicated to be incorporated by reference.

While several variants has been described in the foregoing, it is to be understood that other variations and modification will be apparent to those skilled in the art and that it will be clear to any person skilled in the art that modifications of and adjustments to the foregoing embodiments, not shown, are possible. Those skilled in the art will further understand that the scope of the claims should not be limited by the preferred embodiments set forth in the examples, but should be given the broadest interpretation consistent with the description as a whole.

What is claimed is:

1. A tremolo device comprising, a base plate comprising a bracket for attachment of a lever, and a leading edge comprising an elongate bearing surface, the elongate bearing surface defining an engagement end at a first end of the elongate bearing surface, and a free end at a second end of the elongate bearing surface, the free end being located near the bracket, and a pivot rail comprising an elongate pivot bearing surface with a mating end at one end, so that when the base plate is engaged with the pivot rail, the engagement end of the elongate bearing surface is matingly engaged with the mating end of the pivot rail, to secure pivotal contact between the elongate bearing surface and the elongate pivot bearing surface preventing separation of the engagement end of the base plate from the mating end of the pivot rail while allowing rotation of the base plate about a longitudinal axis of the pivot rail.

2. The tremolo device of claim 1, wherein the mating end comprises a pin aligned along the longitudinal axis of the pivot rail and extending out from the end of the mating end, and the engagement end comprises a recess for matingly receiving the pin.

3. The tremolo device of claim 1, wherein the mating end comprises a surface that defines a recess aligned along the longitudinal axis of the pivot rail, and the engagement end comprises a pin for pivotally engaging the mating end.

4. The tremolo device of claim 1, wherein the mating end comprises a surface that defines a recess aligned along the longitudinal axis of the pivot rail, the engagement end comprises an end wall defining a second recess, the mating end and the engagement end pivotally engaged with a pin that is fit into the mating end and the end wall of the engagement end.

5. The tremolo device of claim 4, wherein the mating end defines a threaded recess aligned along the longitudinal axis of the pivot rail, and the engagement end comprises the end wall defining the second recess, the mating end and the engagement end pivotally engaged with a pin threaded into the mating end and pivotally fit into the end wall of the engagement end.

6. The tremolo device of claim 4, wherein the mating end defines the recess aligned along the longitudinal axis of the pivot rail, and the engagement end comprises the end wall defining a threaded recess, the mating end and the engagement end pivotally engaged with a threaded pin that is threaded into the end wall of the engagement end and pivotally fit into the mating end.

7. The tremolo device of claim 1, wherein the leading edge terminates in a beveled edge to permit rotation of the base plate about a longitudinal axis of the pivot rail.

8. The tremolo device of claim 1, wherein the pivot rail further comprises one or two pins located on an upper surface of the pivot rail, perpendicular to the longitudinal axis of the pivot rail, and the leading edge comprising one or two corresponding slots to receive the one or two pins when the base plate is mounted on the pivot rail.

9. The tremolo device of claim 1, wherein a lever is attached to the bracket.

10. The tremolo device of claim 2, wherein the recess of the engagement end comprises a slot extending from the recess to an opening at a side edge of the engagement end and at an angle from a line perpendicular to the surface of a guitar body, of about 10 degrees to about 80 degrees, when the device is mounted onto the guitar body, the slot to permit sliding insertion of the pin within the slot, and retention of the pin within the recess.

11. The tremolo device of claim 2, wherein the recess of the engagement end comprises an aperture with an opening located within the engagement end.

12. The tremolo device of claim 2, wherein the pin is a spring-loaded pin.

13. The tremolo device of claim 12, wherein an opposing end of the pivot rail comprises a second pin aligned along the longitudinal axis of the pivot rail and extending out from the opposing end, and the free end comprises a recess for matingly receiving the second pin.

14. The tremolo device of claim 3, wherein the pin is a spring-loaded pin.

15. The tremolo device of claim 14, wherein an opposing end of the pivot rail comprises a surface that defines a second recess aligned along the longitudinal axis of the pivot rail, and the free end comprises a second pin for pivotally engaging the opposing end.
